(19) United States
(12) Patent Application Publication
(10) Pub. No.: US 2002/0001373 A1
(43) Pub. Date: Jan. 3, 2002

(54) Internet facsimile gateway apparatus and method for controlling the same

(76) Inventor: Shigeki Sakurai, Kanagawa (JP)

Correspondence Address: MORGAN & FINNEGAN, L.L.P., 345 PARK AVENUE, NEW YORK, NY, 10154, US

(21) Appl. No.: 09/825,023

(22) Filed: Apr. 3, 2001

(30) Foreign Application Priority Data
Apr. 4, 2000 (JP) 2000-102507

(51) Int. Cl. H04M 11/00; H04L 12/66

(52) U.S. Cl. 379/100.12; 379/100.17; 370/352

(57) ABSTRACT

To provide an Internet facsimile gateway apparatus and a controlling method thereof with which mutual communication between facsimile apparatuses are certainly performed without depending on transmission delay of an IP network connecting gateway apparatuses. When receiving CED data from the IP network, an outgoing side gateway apparatus 1001 being an Internet facsimile gateway apparatus according to the present invention transmits a CED signal to an outgoing call side G3 facsimile apparatus 2201. Then, after a predetermined length of time (75±20 ms) defined by G3 facsimile transmission procedures, the outgoing side gateway apparatus 1001 transmits a preamble signal 412 generated from a local preamble data generation section to an outgoing call side G3 facsimile apparatus without waiting for receipt 422 of the IP network. In this way, normal communication can be performed between facsimile apparatuses by generating a pseudo signal and transmitting a signal required for transmission procedures within a predetermined length of time even if transmission delay due to the IP network is large.

### FIELD OF THE INVENTION

The present invention relates to an Internet facsimile gateway apparatus and, in particular, to a gateway apparatus, which is connected to an IP network and a public network, for performing G3 facsimile mutual communication on a real time basis based on the T.38 recommended by the ITU-T.

### BACKGROUND OF THE INVENTION

In recent years, as the Internet can be utilized at low price, there is an increasing tendency to attempt to reduce costs by transmitting voices and facsimiles using the Internet or to attempt to improve transmission efficiency by uniting data such as voices, facsimiles and videos using the Internet (IP network).

FIG. 10 shows a network configuration for transmitting a document in a G3 facsimile apparatus via an IP network. Reference numerals 1201 and 1202 denote an Internet facsimile gateway apparatuses (GWs), which are connected to an IP network 200 and public networks 2101 and 2102, respectively. Reference numerals 2201 and 2202 denote G3 facsimile apparatuses, which are connected to the public networks 2101 and 2102, respectively.

The gateway apparatuses 1201 and 1202 perform communication with the G3 facsimile apparatuses 2201 and 2202 in accordance with the T.30 (a recommendation by the ITU-T and procedures for facsimile transmission of a document in a general switching telephone network) protocol. In addition, the gateway apparatuses mutually perform UDP (User Datagram Protocol in accordance with the RFC768 of the IETF) communication by the IFP (Internet Facsimile Protocol) packet in the UDPTL/IP (Facsimile UDP Transport Layer Protocol) in accordance with the T.38 (a recommendation by the ITU-T and procedures for the real time G3 facsimile communication on the IP network) protocol.

FIG. 11 shows a UDPTL/IP packet configuration defined by the T.38 protocol. A UDPTL/IP packet 300 is composed of an IP header, a UDP header, a UDPTL header and an IFP packet. In addition, the IFP packet is composed of a type and data 310.

FIG. 12 is a block diagram showing a brief configuration of a conventional Internet facsimile gateway apparatus. An Internet facsimile gateway apparatus 1200 shown in FIG. 12 corresponds to the gateway apparatuses 1201 and 1202 in FIG. 10.

In this figure, reference numeral 104 denotes a control section, which controls the entire apparatus. Reference numeral 101 denotes a public network control section, which is connected to a public network and controls incoming and outgoing calls. Reference numeral 102 denotes a facsimile signal processing section performs generation and detection of various kinds of signals defined in the T.30, modulation of data to be transmitted to a public network signal, and demodulation of a signal received form the public network to digital data. Reference numeral 103 denotes a T.30 protocol processing section, which performs protocol processing in accordance with the T.30 protocol. Reference numeral 106 denotes a packet processing section, which assembles and disassembles the UDPTL/IP packet and takes out data in the IFP from the UDPTL/IP packet. Reference numeral 105 denotes a data buffer, which stores transmission and reception data of the IFP packet. Reference numeral 109 denotes a LAN control section, which performs control of transmission of data to a LAN or receipt of data from a LAN.

A part of mutual communication operations of G3 facsimile apparatuses via the IP network will be hereinafter described with reference to FIGS. 13 and 14.

FIG. 13 shows a signal sequence from the time when an outgoing call side G3 facsimile apparatus (the G3 facsimile apparatus 2201 in FIG. 10) makes a transmission until the time when it receives a DIS (Digital Identification Signal) from an incoming call side G3 facsimile apparatus (the G3 facsimile apparatus 2202 in FIG. 10) (however, operations of a switching machine of the public network is omitted).

In FIG. 13, reference numeral 400 denotes a signal state of the outgoing call side G3 facsimile apparatus 2201, reference numeral 401 denotes a signal state of the outgoing side gateway apparatus 1201, reference numeral 402 denotes a signal state of the incoming side gateway apparatus 1202, and reference numeral 403 denotes a signal state of the incoming side G3 facsimile apparatus 2202, respectively. When receiving transmission 410 from the outgoing call side G3 facsimile apparatus 2201, the outgoing side gateway apparatus 1201 transmits transmission information 420 to the incoming side gateway apparatus 1202. When receiving the transmission information 420, the incoming side gateway apparatus 1202 transmits receipt 430 to the incoming call side G3 facsimile apparatus 2202.

When responding to the receipt 430, the incoming call side G3 facsimile apparatus 2202 transmits a CED (Called station identification) signal 431 in accordance with the T.30 protocol. When receiving the CED signal, the incoming side gateway apparatus 1202 transmits CED data 421 by an IFP packet frame in accordance with the T.38 protocol. When receiving the CED data 421, the outgoing side gateway apparatus 1201 transmits a CED signal 411 to the outgoing call side G3 facsimile apparatus 1201 in accordance with the T.30 protocol.

After transmitting the CED signal 431, the incoming call side G3 facsimile apparatus 2202 transmits a preamble signal 432 following a no-signal state 450 of 75±20 ms. The incoming gateway apparatus 1202 transmits preamble data 422 by an IFP packet. At this point, since an IP network 200 is provided between the incoming side gateway apparatus 1202 and the outgoing side gateway apparatus 1201, transmission delay occurs which is generally longer than that occurring in a telephone switched network. When a delayed time of the IP network at a time t is assumed to be Td(t) ms, it takes Td(t) ms for the IFP packet of the preamble data 422 to reach the outgoing side gateway apparatus 1201.

Thereafter, since the outgoing side gateway apparatus 1201 transmits a preamble signal 425 to the outgoing call side G3 facsimile apparatus 2201 in accordance with the T.30 protocol, a no-signal state 428 between the preamble signal 425 and the CED signal 411 which reach the outgoing call side G3 facsimile apparatus 2201 occurs for (75±20)+Td(t)ms.

The incoming call side G3 facsimile apparatus 2202 transmits a CSI (Called Subscriber Identification) signal 433 and a DIS (Digital Identification Signal) 434 following the preamble signal 425. The incoming side gateway apparatus 1202 transmits CSI data 423 and DIS data 424 to the outgoing side gateway apparatus 1201 by an IFP packet frame. The outgoing side gateway apparatus 1201 transmits the received data to the outgoing call side G3 facsimile apparatus 2201 as a CSI signal 426 and DIS 427.

FIG. 14 shows a signal sequence for switching a low speed modem to a high speed modem and training the high speed modem prior to transmission of image data from the outgoing call side G3 facsimile apparatus 2201. The outgoing side G3 facsimile apparatus 2201 continuously transmits a preamble signal 800, a TSI (Transmitting Subscriber Identification) signal 801 and a DCS (Digital Command Signal) 802 by a low speed modem. When receiving these signals, the outgoing side gateway apparatus 1201 continuously transmits an IFP packet of preamble data 810, an IFP packet of TSI data 811 and an IFP packet 812 of DCS data in accordance with the T.38 protocol.

The incoming side gateway apparatus 1202 transmits a preamble signal 815, a TSI signal 816 and a DCS signal 817 to the incoming call side G3 facsimile apparatus 2202 in accordance with the T.30 protocol, respectively. After transmitting the DCS signal 802, the outgoing call side G3 facsimile apparatus 2201 causes a no-signal state 830 of 75±20 ms to occur, and then transmits a training signal 803 for training the high speed modem. When receiving the training signal 803, the outgoing side gateway apparatus 1201 transmits an IFP packet of training signal 813 to the incoming side gateway apparatus 1202 in accordance with the T.38 protocol.

At this point, as described in FIG. 13 as well, delay of Td(t) ms occurs in data transmission by the IP network between the outgoing side gateway apparatus 1201 and the incoming side gateway apparatus 1202. Therefore, it takes Td(t) ms since the transmission by the outgoing side gateway apparatus 1201 for the IFP packet to reach the incoming side gateway apparatus 1202. When receiving the IFP packet, since the incoming side gateway apparatus 1202 transmits a training signal 818 in accordance with the T.30 protocol, a no-signal state 820 between the DCS 817 and the training signal 818 which reach the incoming call side G3 facsimile apparatus 2202 occurs for (75±20)+Td(t)ms.

The outgoing call side G3 facsimile apparatus 2201 transmits a TCF (Training Check) signal 804 following the training signal 803, the outgoing side gateway apparatus 1201 transmits an IFP packet 814 of TCF data to the incoming side gateway apparatus 1202 in the same manner as it transmits other signals, and the incoming side gateway apparatus 1202 transmits a TCF signal 819 to the incoming call side G3 facsimile apparatus 2202.

As described above, in the conventional gateway apparatus, a no-signal interval that is a no-signal interval generated by the G3 facsimile apparatus in accordance with the T.30 protocol to which transmission delay via the IP network is added occurs in a counterpart's facsimile apparatus. Thus, depending on a length of a no-signal interval generated by the G3 facsimile apparatus and an amount of transmission delay of the IP network, a length of a no-signal interval of a defined value of the T.30 protocol, for example, 75±20 ms could not be satisfied. Therefore, due to this extended no-signal state, a phenomenon occurred in which an echo suppressor or an echo canceller of a public network operated and a full duplex communication between G3 facsimile apparatuses was not normally performed.

### SUMMARY OF THE INVENTION

The present invention has been devised in view of these problems of the conventional art, and it is an object of the present invention to provide an Internet facsimile gateway apparatus and a method for controlling the same which can certainly perform mutual communication between facsimile apparatuses without depending on transmission delay of an IP network that connects between gateway apparatuses.

That is, an aspect of the present invention is an Internet facsimile gateway apparatus that is connected to a general switched telephone network and an IP network and relays facsimile communication between the general switched telephone network and the IP network, which comprises: first communicating means for performing procedural processing of facsimile transmission in the general switched telephone network; second communicating means for performing procedural processing of facsimile transmission in the IP network; and controlling means for controlling a transmission timing of a signal transmitted from the first communicating means based on a signal received by the second communicating means.

In addition, another aspect of the present invention is a method for controlling an Internet facsimile gateway apparatus that is connected to a general switched telephone network and an IP network and relays facsimile communication between the general switched telephone network and the IP network, which comprises: a first communication step of performing procedural processing of facsimile transmission in the general switched telephone network; a second communication step of performing procedural processing of facsimile transmission in the IP network; and a control step for controlling a transmission timing of a signal transmitted by the first communication step based on a signal received by the second communication step.

In addition, another aspect of the present invention is a computer readable recording medium that stores a control program of an Internet facsimile gateway apparatus that is connected to a general switched telephone network and an IP network and relays facsimile communication between the general switched telephone network and the IP network, which comprises: a program of a first communication step for performing procedural processing of facsimile transmission in the general switched telephone network; a program of a second communication step for performing procedural processing of facsimile transmission in the IP network; and a program of a control step for controlling a transmission timing of a signal transmitted by the program of the first communication step based on a signal received by the program of the second communication step.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of a configuration of an Internet facsimile gateway apparatus in accordance with an embodiment of the present invention;

FIG. 2 is a schematic illustration showing a network configuration of the embodiment of the present invention;

FIG. 3 is a schematic illustration showing an outgoing side signal sequence in accordance with a first embodiment of the present invention;

FIG. 4 is a flow chart showing operations of an Internet facsimile gateway apparatus in accordance with the first embodiment of the present invention;

FIG. 5 is a schematic illustration showing an outgoing side signal sequence in accordance with a second embodiment of the present invention;

FIG. 6 is a flow chart showing operations of an Internet facsimile gateway apparatus in accordance with the second embodiment of the present invention;

FIG. 7 is a schematic illustration showing an incoming side signal sequence in accordance a third embodiment of the present invention;

FIG. 8 is a flow chart showing operations of an Internet facsimile gateway apparatus in accordance with the third embodiment of the present invention;

FIG. 9 is a schematic illustration sowing an example of stored contents of a sequence storage section in accordance with the embodiment of the present invention;

FIG. 10 is a schematic illustration showing a conventional network configuration;

FIG. 11 is a schematic illustration showing a configuration of a UDPTL/IP packet;

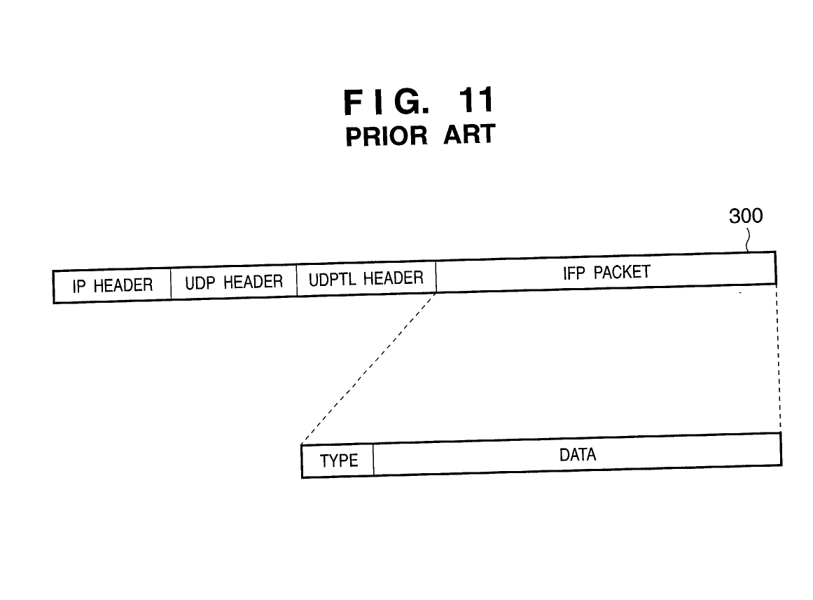

FIG. 12 is a block diagram showing an example of a configuration of a conventional Internet facsimile gateway apparatus;

FIG. 13 is a schematic illustration showing a conventional outgoing side signal sequence; and

FIG. 14 is a schematic illustration showing a conventional incoming side signal sequence.

### DETAILED DESCRIPTION OF THE PREFERRED EMBODIMENTS

Preferred embodiments of the present invention will now be described in detail in accordance with the accompanying drawings.

[First Embodiment]

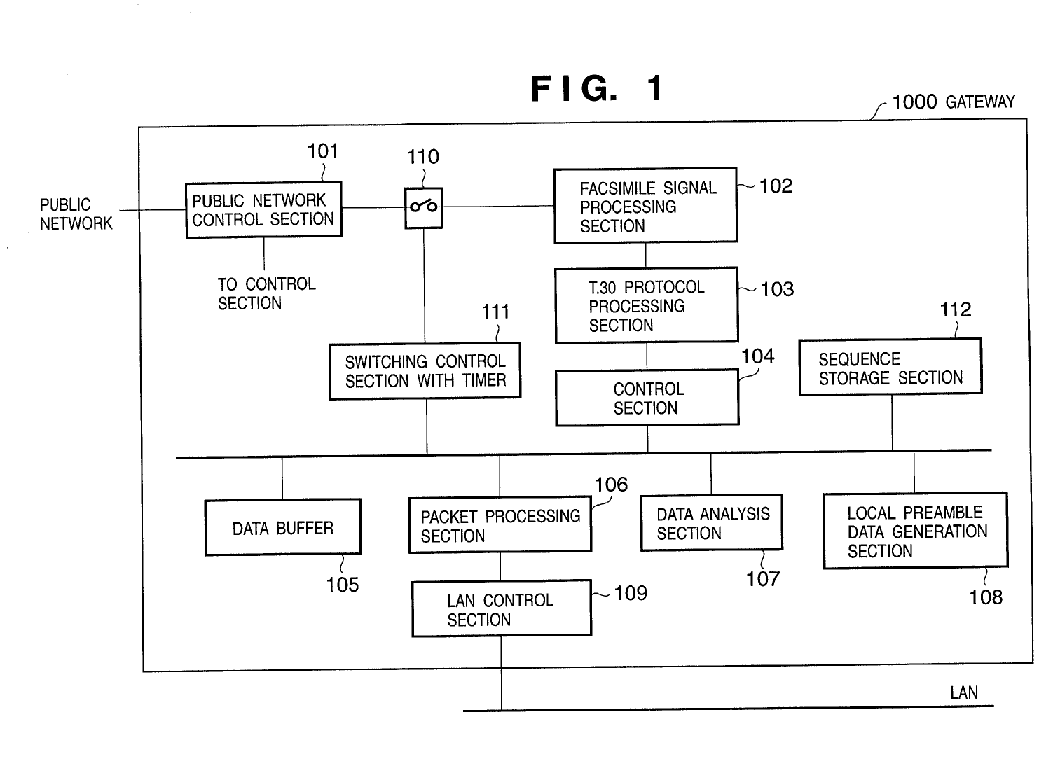

FIG. 1 is a block diagram showing an example of a configuration of an Internet facsimile gateway apparatus in accordance with a first embodiment of the present invention.

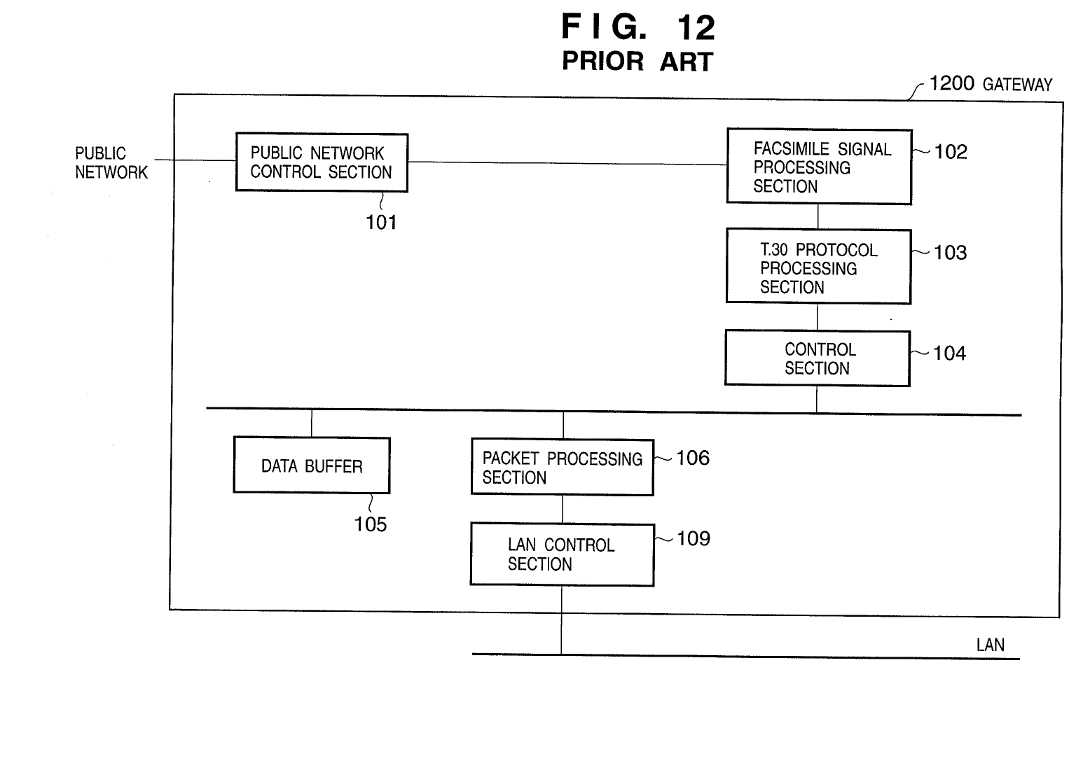

In FIG. 1, same reference numerals are given to elements 101 to 106 and 109 that are the same as those in a conventional Internet facsimile gateway apparatus 1200 shown in FIG. 12, and repeated descriptions are omitted.

Reference numeral 107 denotes a data analysis section, which analyzes data stored in a data buffer 105. Reference numeral 108 denotes a local preamble data generation section, which stores preamble signals determined in advance. Reference numeral 110 denotes a no-signal state generation section, which generates a no-signal state to a public network. Reference numeral 111 denotes a switching control section with a timer, which switches a state of a no-signal state generation section 110 for a predetermined length of time in accordance with an instruction of a control section 104. Reference numeral 112 denotes a sequence storage section, which stores a signal of the T.30 , information received from the IP network 1200, and operations to the public network which should be performed according to the received information, and is referenced by a data analysis section 107.

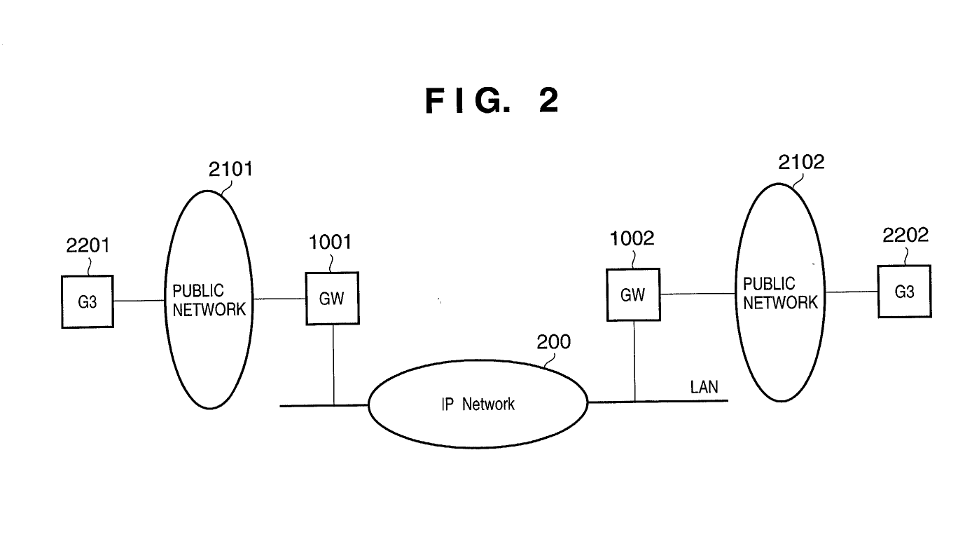

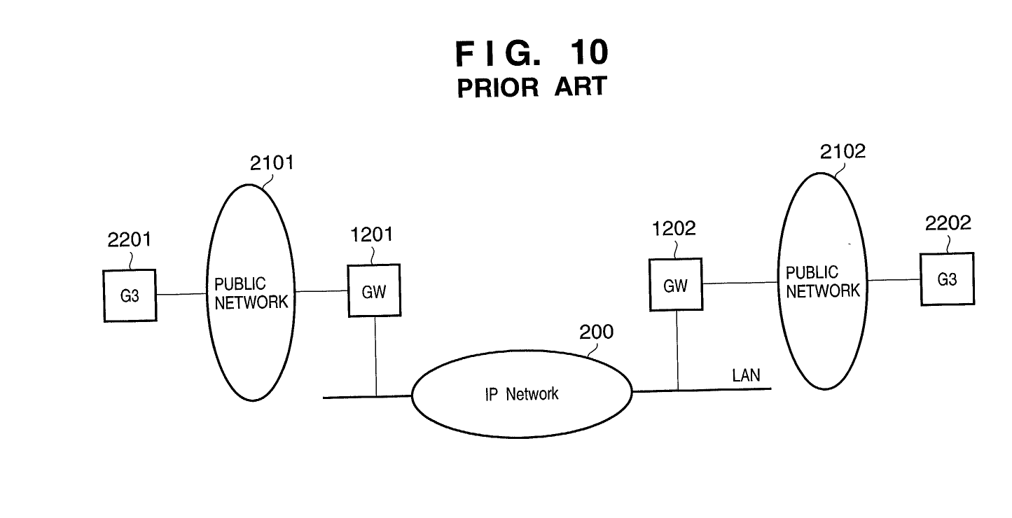

FIG. 2 shows a network configuration for transmitting a document of the G3 facsimile apparatus via the IP network, which has the Internet facsimile gateway apparatuses 1001 and 1002 having the configuration shown in FIG. 1 instead of Internet facsimile gateway apparatuses 1201 and 1202 in FIG. 10.

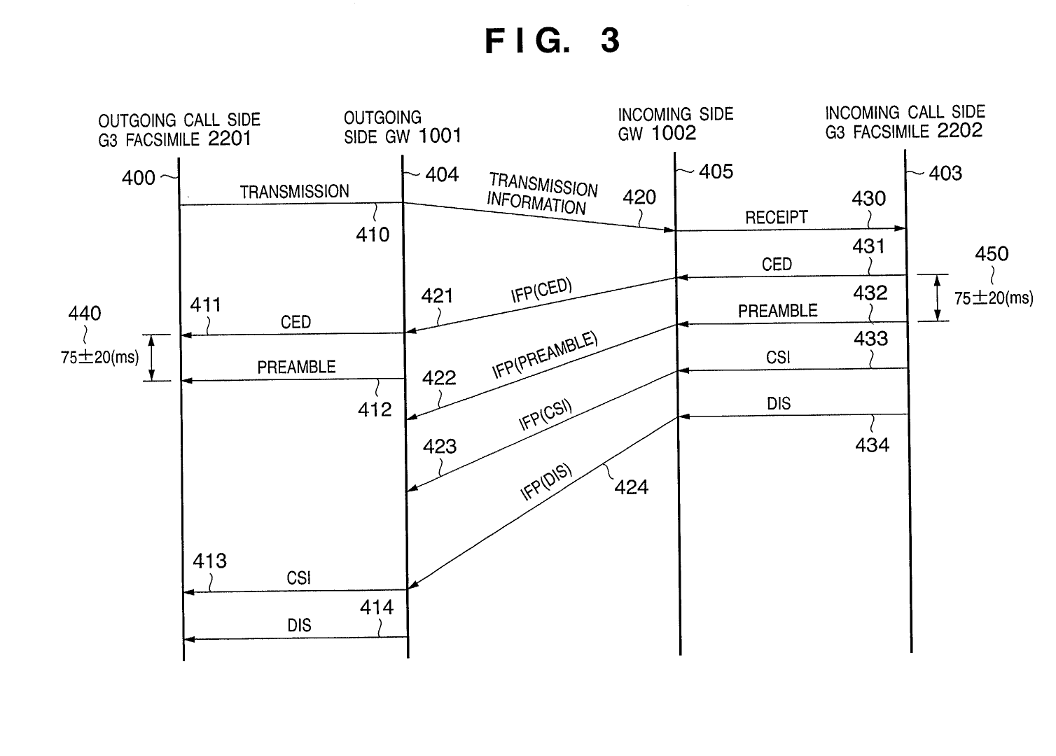

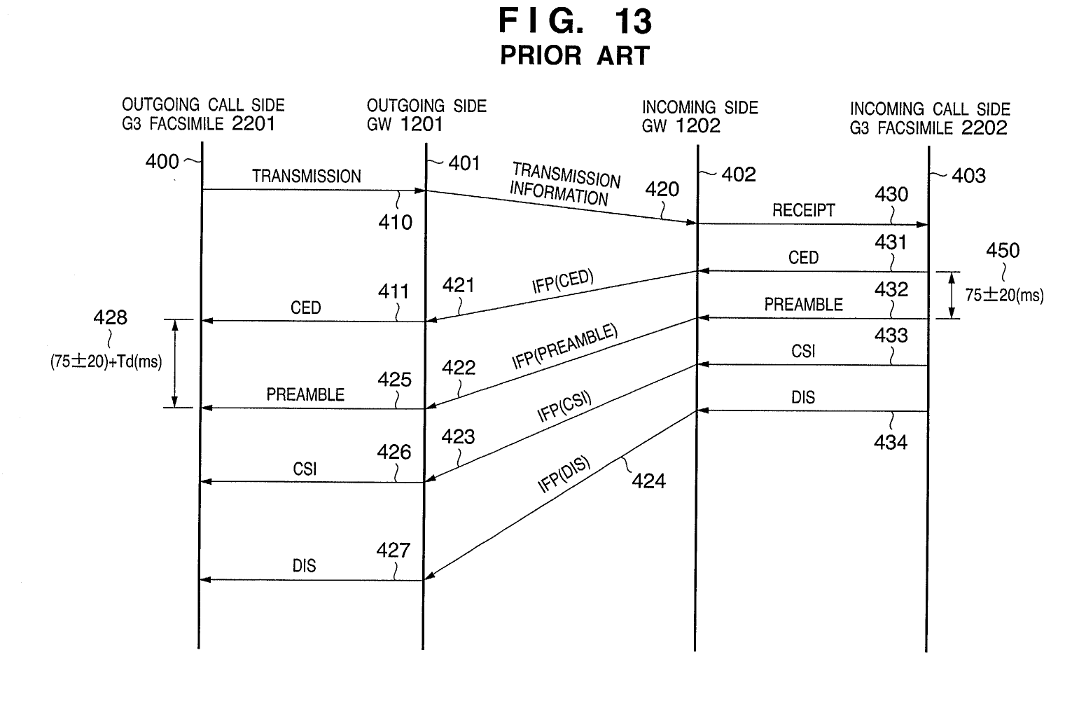

Operations of the Internet facsimile gateway apparatus in this embodiment will be hereinafter described. FIG. 3 shows a part of mutual communication operations of the G3 facsimile apparatus via the IP network as FIG. 13 does. In addition, in the following description, sequence operations since an outgoing call side G3 facsimile apparatus 2201 makes a transmission until it receives a DIS from an incoming call side G3 facsimile apparatus 2202 are described.

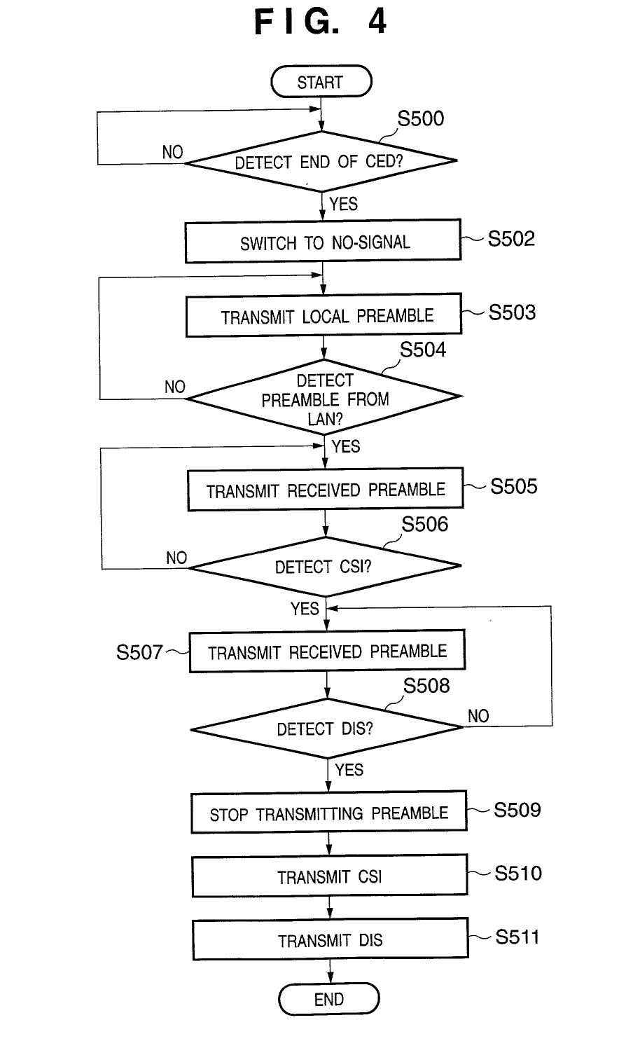

FIG. 3 shows an outgoing side signal sequence, and FIG. 4 shows an operation flow chart of the Internet facsimile gateway apparatus 1001 in the outgoing side. However, operations of a switch board of a public network are omitted. In FIG. 3, reference numeral 400 denotes a signal state of the outgoing call side G3 facsimile apparatus 2201, reference numeral 404 denotes a signal state of the outgoing side gateway apparatus 1001, reference numeral 405 denotes a signal state of the incoming side gateway apparatus 1002, and reference numeral 403 denotes a signal state of the incoming call side G3 facsimile apparatus 2202, respectively. In addition, same reference numerals are given to signals that are the same as those in FIG. 13.

Here, transmission 410 indicates that operations for connecting to the outgoing side gateway apparatus (GW) 1001 is performed and the outgoing call side G3 facsimile apparatus 2201 is in the transmission state via the a public network 2101. In addition, the incoming side gateway apparatus (GW) 1002 indicates that a receipt signal 430 is notified to the G3 facsimile apparatus 2202 via a public network 2102, and indicates that the G3 facsimile apparatus 2202 is in the receipt state. Moreover, it goes without saying that various signals in accordance with the T.30 protocol are transmitted and received via the public networks 2101 and 2102.

In addition, in the following description, elements of the Internet facsimile gateway apparatuses 1001 and those of the Internet facsimile gateway apparatuses 1002 are distinguished by attaching “1” and “2” at the last of the reference numerals, respectively. For example, a public network control section of the Internet facsimile gateway apparatus 1001 is represented as 1011, and a public network control section of the Internet facsimile gateway apparatus 1002 is represented as 1012.

First, when it is assumed that the outgoing call side G3 facsimile apparatus 2201 receives the transmission 410, the outgoing side GW 1001 detects a transmission state by a control section 1041 via the public network control section 1011. Then, information of the outgoing call side G3 facsimile apparatus 2201, transmission information 420 such as a telephone number of a counterpart, or the like is transmitted to the incoming side GW 1002 by a TCP/IP packet via a packet processing section 1061, an LAN control section 1091, an LAN and an IP network 200.

When the incoming side GW 1002 receives and detects the transmission information 420 via an LAN control section 1092 and a packet processing section 1062, the public network control section 1012 moves to incoming connection operations to the incoming call side G3 facsimile apparatuses 2202. When detecting a predetermined receipt 430, the incoming call side G3 facsimile apparatus 2202 transmits the CED signal 431 immediately to the receipt GW 1002.

When the incoming side GW 1002 receives the CED signal 431 in the public network control section 1012 and the CED signal is detected in the facsimile signal processing section 1022, the detection data is communicated to a control section 1042 via a T.30 protocol processing section 1032. The control section 1042 instructs a packet processing section 1062 to communicate the CED data (a data value indicating the CED) to the outgoing side GW 1001 by a UDPTL/IP packet. The packet processing section 1062 puts the CED data in a data section 310 of the IFP packet, and transmits it to the IP network 200 via the LAN control section 1092.

When received by the LAN control section 1091 of the outgoing side GW 1001, a UDPTL/IP packet 421 including the CED data is disassembled into IFP packets in the packet processing section 1061, and the CED data of the data section 310 is stored a the data buffer 1051 one after another. The control section 1041 reads the stored data from the data buffer 1051 one after another, and transfers the data to a data analysis section 1071.

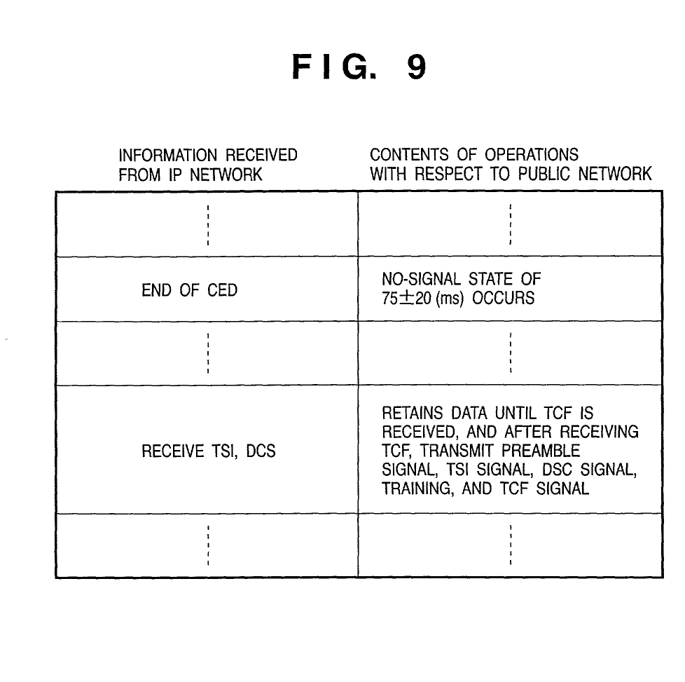

The data analysis section 1071 performs analysis of data, and determines whether or not the data coincides with defined sequence signal information by accessing a sequence storage section 1121. When the control section 1041 recognizes that CED data and the received data because the CED data is stored in the sequence storage section 1121, the control section 1041 performs operations in accordance with an operational sequence stored in the sequence storage section 1121 as well. That is, as shown in FIG. 9, when the end of the CED signal is detected, the control section 1041 operates such that a no-signal state of 75±20 ms is generated with respect to the public network. This operation will be hereinafter described in detail using the flow chart shown in FIG. 4.

When confirming the receipt of the CED, the control section 1041 issues a CED transmission instruction to a T.30 protocol processing section 1031. The T.30 protocol processing section 1031 forwards CED data to a facsimile processing section 1021 instructing the facsimile processing section 1021 to transmit the CED signal 411. Then, the CED signal 411 is transmitted to the outgoing call side G3 facsimile apparatus 2201. When the data analysis section 1071 detects the end of the CED (step S500), the transmission of the CED signal 411 is stopped, and the control section 1041 instructs a switching control section with timer 1111 to switch a no-signal state generation section 1101 to a no-signal state.

Thereafter, the no-signal state generation section 1101 is activated, and a no-signal state 440 of 75±20 ms is generated to the public network 2101 (step S502). After the no-signal state of 75±20 ms, the switching control section 1111 switches the no-signal state generation section 1101 from the no-signal state to the facsimile signal processing section 1021 side. Then, the control section 1041 reads the preamble data from a local preamble data generation section 1081, demodulates the data in the facsimile signal processing section 1021 via the T.30 protocol processing section 1031, and transmits the demodulated data to the outgoing call side G3 facsimile apparatus 2201 as a preamble signal 412 (step S503).

In this way, it is seen that the no-signal state of 75±20 ms can be certainly secured by the outgoing side GW 1001 transmitting a preamble signal locally. After finishing transmitting the CED signal 431 for a predetermined length of time, the incoming call side G3 facsimile apparatus 2202 transmits a preamble signal 432 through a no-signal state 450 of 75±20 ms.

A UDPTL/IP packet 432 in which the preamble data 422 was put in the data section of the IFP packet is transmitted to the outgoing side GW 1001 via the incoming side GW 1002 and the IP network 200. when the outgoing side GW 1001 receives this packet 432, the preamble data is detected in the data analysis section 1071 via the LAN control section 1091, the packet processing section 1061 and the data buffer 1051 (step S504).

When the preamble signal from the incoming call side G3 facsimile apparatus 2202 is detected, the outgoing side GW 1001 stops the transmission of the local preamble data signal 412, and continues to transmit a preamble signal based on preamble data read from the data buffer 1051. In this case, the local preamble signal can be transmitted without change.

After transmitting the preamble signal 432 for a predetermined length of time, the incoming call side G3 facsimile apparatus 2202 continuously transmits a CSI (Called Station Identification) signal 433 and a DIS (Digital Identification Signal) 434. CSI data 423 and DIS data 424 are put in the data section of the IFP packet in the incoming side GW 1002, respectively, and transmitted to the outgoing side GW 1001 by the UDPTL/IP packets 423 and 424.

Although the outgoing side GW 1001 performs processing in a route similar to that of the preamble data 422, if the CSI packet 423 and the DIS packet 424 do not reach the outgoing side GW 1001 continuously (substantially simultaneously), the outgoing side GW 1001 transmits a CSI signal 413 and a DIS signal 414 one after another to the outgoing call side G3 facsimile apparatus 2201 after DIS data 424 reaches the outgoing side GW 1001.

That is, even after detecting the CSI (step S506), the outgoing side GW 1001 continues to transmit a preamble signal while retaining the CSI data (step S507). Thereafter, when detecting the DIS data (step S508), the outgoing side GW 1001 stops the transmission of the preamble signal (step S509), transmits the CSI signal 413 (step S510), and successively transmits the DIS signal 414 (step S511). In this way, the CSI signal and the DIS signal can be transmitted to the G3 facsimile apparatus within a predetermined length of time with retaining synchronism as established.

[second Embodiment] In the first embodiment, if the UDPTL/IP packet including the CSI data from the incoming side GW 1002 and the packet including the DIS data do not reach continuously (substantially simultaneously), the transmission of the preamble signal is continued until the receipt of the DIS data is detected. The second embodiment is characterized by transmitting the CSI signal first in such a case.

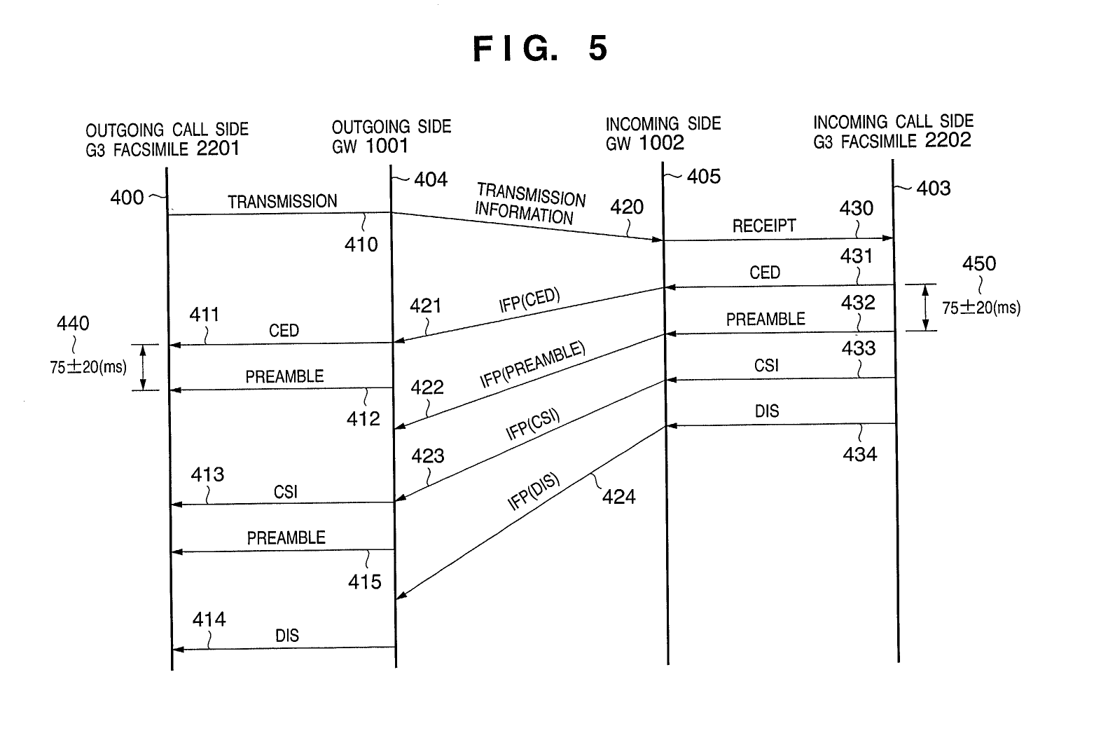

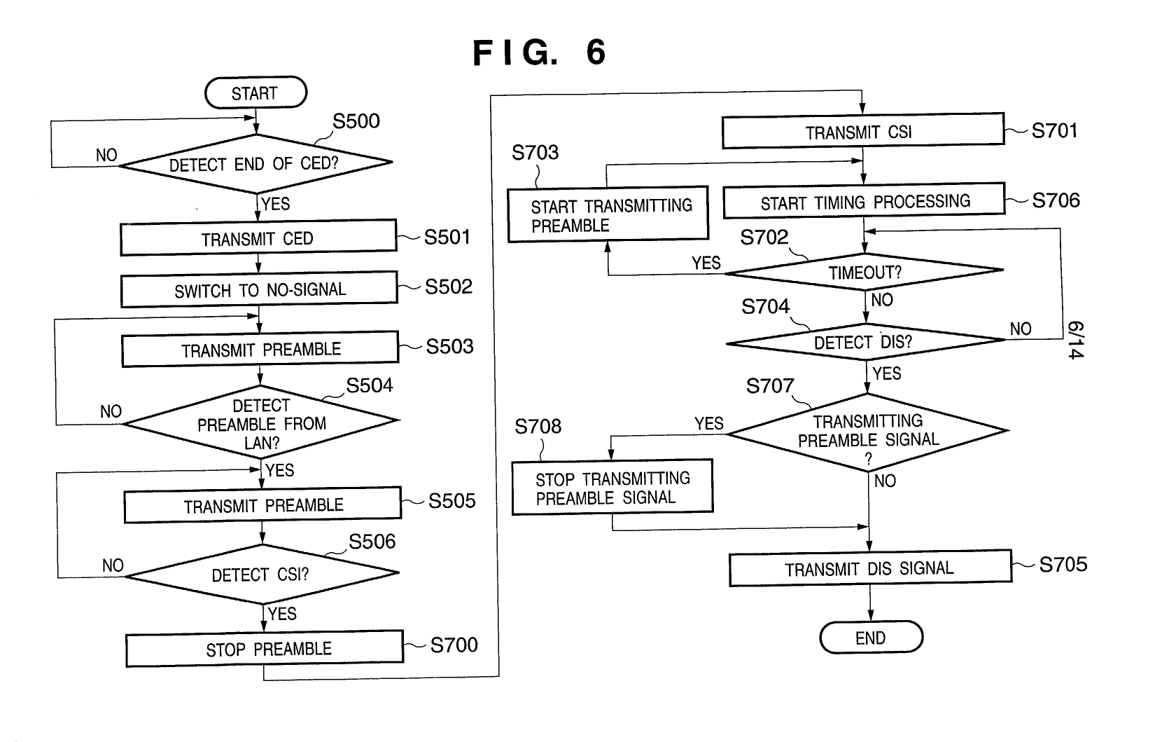

Operations of the outgoing side GW 1101 in this embodiment will be hereinafter described using a sequence chart shown in FIG. 5 and a flow chart shown in FIG. 6. Further, in the sequence chart of FIG. 5 and the flow chart of FIG. 6, identical reference numerals are given to the signals and processing with the contents identical with those of the sequence chart of FIG. 3 and the flow chart of FIG. 4, and repeated descriptions are omitted.

Therefore, only processing after the step S506 and a sequence after receiving the CSI packet 423 will be hereinafter described. When detecting the receipt of the CSI packet 423 (step S506), the outgoing side GW 1101 once stops the transmission of the preamble signal (step S700). Then, the outgoing side GW 1101 generates the CSI signal 413 from the CSI packet 423 that has reached earlier, and transmits it to the outgoing call side G3 facsimile apparatus 2201 (step S701).

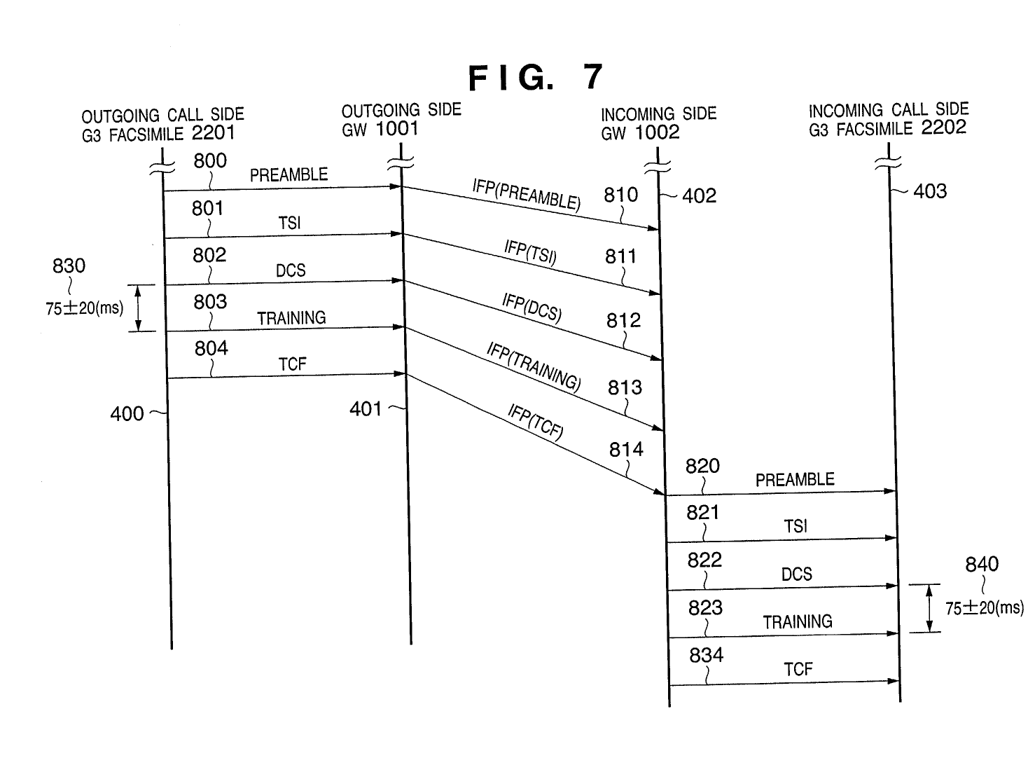

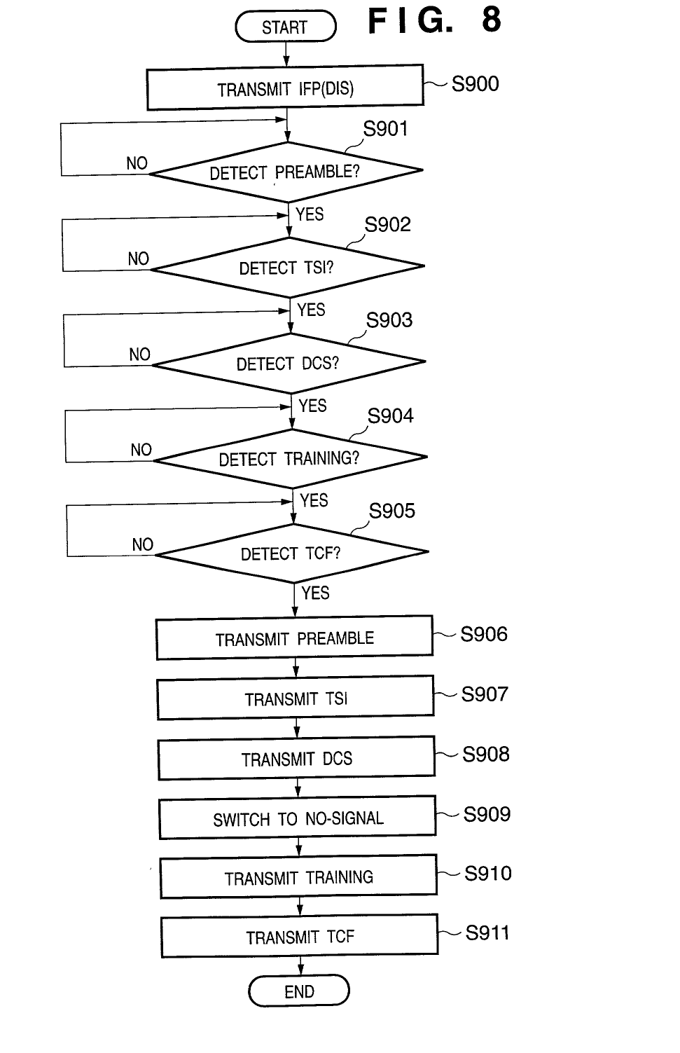

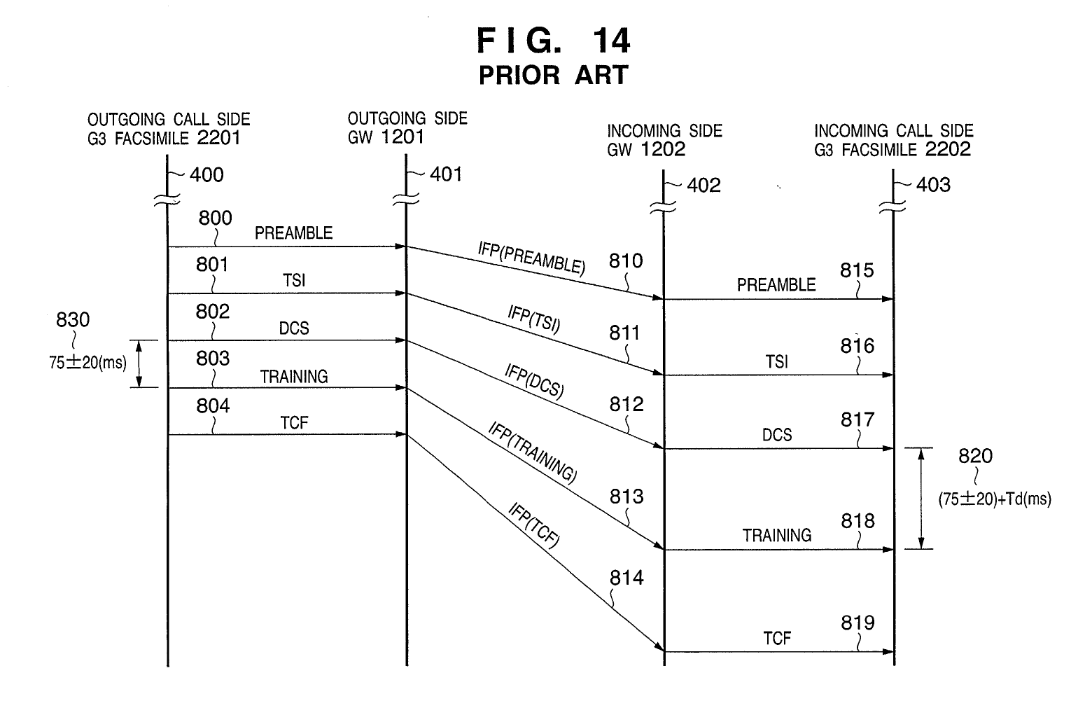

Then, the outgoing side GW 1001 starts timing of a predetermined length of time in order to measure time-out of the DSI data detection (step S706). If the DSI data is detected in the predetermined length of time (step S702 to S704), the outgoing side GW 1001 transmits the data to the G3 facsimile apparatus 2201 by switching to the DIS signal 414 (step S707 to S705). If the DSI data is not detected when the predetermined length of time has passed, the outgoing side GW 1001 determines time-out in step S702, starts the transmission of the preamble signal 415 (step S703), and starts the timing processing again while retaining synchronism. Thereafter, if the DSI data is detected (step S704), the outgoing side GW 1001 stops the transmission of the preamble signal (step S708) and then transmits DIS signal 414 (step S705). In this way, communication is continuously established without breaking the synchronism of the outgoing call side G3 facsimile apparatus 2201 and the outgoing side GW 1001.

[Third embodiment] Operations for switching to a high speed modem and training the high speed modem prior to transmitting image data from the outgoing call side G3 facsimile apparatus 2201 will now be described with reference to FIGS. 7 and 8. FIG. 7 shows a signal sequence and FIG. 8 shows an operation flow chart of the incoming side Internet facsimile gateway apparatus 1002 of this embodiment. Further, in FIG. 7, same reference numerals are given to signals that are the same as those in the conventional incoming side signal sequence shown in FIG. 14.

As described in the first and the second embodiments, when transmitting various signals to the outgoing side GW 1101 after receipt, and transmitting the UDPTL/IP packet having the DIS data (step S900), the incoming side GW 1002 is in the state of waiting for data from the outgoing side GW 1101.

The outgoing call side G3 facsimile apparatus 2201 continuously transmits a preamble signal 800, a TSI (Transmitting Station Identification) signal 801 and a DCS (Digital Command Signal) 802 by a low speed modem. When the outgoing side GW 1001 receives these signals, the signals are transferred to the control section 1041 via the public network control section 1011, the facsimile processing section 1021 and the T.30 protocol processing section 1031.

The preamble data, the TSI data and DCS data are put in the data section of the IFP packet, respectively, in accordance with the T.38 protocol in the packet processing section 1061, and are transmitted to the IP network 200 by the UDPTL/IP packet 810, 811 and 812. The incoming side GW 1002 receives these packets in the LAN control section 1092, disassembles them into data of the IFP packet in the packet processing section 1062, and stores each piece of the data in the data buffer 1052 one after another (step S901 to S903). The control section 1042 transfers these pieces of the data to the data analysis section 1072 one after another.

The data analysis section 1072 notifies the control section 1042 of analysis results. At this point, the data analysis section 1072 accesses a sequence storage section 1122. As shown in FIG. 9, information received from the IP network 200 and operations with respect to the public network that should be performed according to the information are stored in the sequence storage section. Therefore, since the data analysis section 1072 can recognize in advance a sequence to be switched to a training signal because a non-signal state of 75±20 ms follows the DCS by accessing the sequence storage section 1122, the data analysis section 1072 operates to retain the data without transmitting each signal to the incoming call side G3 facsimile apparatus 2202 immediately in accordance with the contents of operations in FIG. 9.

The outgoing call side G3 facsimile apparatus 2201 generates a no-signal state 830 of 75±20 ms after the transmission of the DCS signal 802 and, then, transmits the training signal 803 of the high speed modem. When receiving the training signal 803, the outgoing side GW 1001 puts training data in the data section of the IFP packet and transmits the data to the incoming side GW 1002 by the UDPTL/IP packet 813 according to the similar processing routes as described above.

In addition, the outgoing call side G3 facsimile apparatus 2201 transmits a TCF (Training Check) signal after transmitting the training signal 803 for a predetermined length of time. The TCF data is also transmitted to the incoming side GW 1002 by the UDPTL/IP packet 814. When the incoming side GW 1002 receives the training data (step S904) and receives the TCF data (step S905), the control section 1042 reads the pieces of data from the data buffer 1052 one after another, and transmits the data to the facsimile signal processing section 1022 via the T.30 protocol processing section 1032.

The facsimile signal processing section 1022 demodulates these pieces of data to a facsimile communication signal, transmits a preamble signal 820 (step S906), transmits a TSI signal 821 (step S907) and transmits a DCS signal 822 (step S908) to the incoming call side G3 facsimile apparatus 2202, and, then, the control section 1042 instructs a switching control section 1112 with timer to switch to a no-signal state of 75±20 ms (step S909) and creates a no-signal state 840.

Thereafter, when the no-signal state is finished by the switching control section 1112 with timer, the facsimile signal processing section 1022 transmits a training signal 823 (step S910) and then transmits a TCF signal 824. In this way, a length of time of the no-signal state from the receipt of the DCS signal to the receipt of the training signal of 75±20 ms can be accurately secured in the incoming call side G3 facsimile apparatus 2202.

Although a gateway apparatus for communication between G3 facsimile apparatuses is described in the above-mentioned embodiment, the present invention may be a gateway apparatus of an apparatus for performing facsimile communication by other standards because the essence of the present invention is in generating a pseudo signal in gateway apparatuses when normal communication is difficult between facsimile apparatuses due to transfer delay by an IP network between the gateway apparatuses or realizing normal communication by controlling a transmission timing of a signal.

In addition, it goes without saying that a facsimile apparatus needs not to be a machine only for a facsimile, but an apparatus having a function of facsimile communication will suffice. That is, a facsimile apparatus may be a copying machine having a facsimile communication function, a computer apparatus having a facsimile modem or the like.

Further, the present invention may be applied to a system composed of a plurality of apparatuses (e.g., a host computer, interface equipment, a reader and a printer) or may be applied to an apparatus consisting of one appliance (e.g., a copying machine and a facsimile apparatus).

In addition, it goes without saying that the object of the present invention can be attained by supplying a storage medium (or a recording medium) that records a program code of software for realizing the functions of the above-mentioned embodiments to a system or an apparatus, and by a computer (CPU or MPU) of the system or the apparatus reading and executing the program code stored in the storage medium. In this case, since the program code itself read from the storage medium realizes the functions of the above-mentioned embodiments, and the storage medium storing the program code constitutes the present invention. In addition, the object of the present invention can also be attained not only in the case in which the functions of the above-mentioned embodiments are realized by executing a program code read by a computer but also in the case in which an operating system (OS) or the like that runs on the computer performs a part or all of actual processing based on the instruction of the program code, thereby realizing the functions of the above-mentioned embodiments.

Moreover, the object of the present invention can also be attained in the case in which, after a program code read from the storage medium is written in a memory provided in a function extension card inserted in a computer or a function extension unit connected to a computer, a CPU or the like provided in the function extension card or the function extension unit performs a part or all of actual processing, thereby realizing the functions of the above-mentioned embodiments.

If the present invention is applied to the above-mentioned storage medium, a program code corresponding to a flow chart described before (shown in any one of FIGS. 4, 6 and 8)is stored in the storage medium.

As described above in detail, according to the present invention, since a necessary signal is transmitted and a no-signal state can be created even in the case in which time delay occurs in an IP network, mutual communication with a G3 facsimile apparatus can be secured, and full duplex communication can be performed without operating an echo suppressor or an echo canceller of a public network. Therefore, a high quality apparatus with high reliability can be provided which is capable of performing real time Internet facsimile communication between G3 facsimile apparatuses via an IP network and is not affected by time delay of the IP network.

Furthermore, the present invention can be applied to the system comprising either a plurality of units or a single unit. It is needless to say that the present invention can be applied to the case which can be attained by supplying programs which execute the process defined by the present system or invention.

What is claimed is:

1. An Internet facsimile gateway apparatus that is connected to a general switched telephone network and an IP network and relays facsimile communication between said general switched telephone network and said IP network, comprising:
first communicating means for performing procedural processing of facsimile transmission in said general switched telephone network;
second communicating means for performing procedural processing of facsimile transmission in said IP network; and
controlling means for controlling a transmission timing of a signal transmitted from said first communicating means based on a signal received by said second communicating means.

2. The Internet facsimile gateway apparatus according to claim 1, wherein said controlling means has a pseudo signal generating means for generating a pseudo signal of a control signal to be used in procedures of facsimile transmission in said general switched telephone network, and, after said second communicating means receives a predetermined signal, transmits said pseudo signal after a predetermine time via said first communicating means.

3. The Internet facsimile gateway apparatus according to claim 1, wherein, after said second communicating means accumulates received signals for a predetermined period of time, said controlling means transmits the accumulated signals via said first communicating means.

4. The Internet facsimile gateway apparatus according to claim 2, wherein said pseudo signal is a signal for establishing synchronism between transmission/reception apparatuses.

5. The Internet facsimile gateway apparatus according to claim 2, wherein said predetermined period of time is a length of time defined by procedures for facsimile transmission in said general switched telephone network.

6. A method for controlling an Internet facsimile gateway apparatus that is connected to a general switched telephone network and an IP network and relays facsimile communication between the general switched telephone network and the IP network, comprising:
a first communication step of performing procedural processing of facsimile transmission in said general switched telephone network;
a second communication step of performing procedural processing of facsimile transmission in said IP network; and
a control step for controlling a transmission timing of a signal transmitted by said first communication step based on a signal received by said second communication step.

7. The method for controlling an Internet facsimile gateway apparatus according to claim 6, wherein said controlling step has a pseudo signal generating step for generating a pseudo signal of a control signal to be used in procedures of facsimile transmission in said general switched telephone network, and, after said second communicating step receives a predetermined signal, transmits said pseudo signal after a predetermine time by said first communicating step.

8. The method for controlling an Internet facsimile gateway apparatus according to claim 6, wherein, after said second communicating step accumulates received signals for a predetermined period of time, said controlling step transmits the accumulated signals by said first communicating step.

9. The method for controlling an Internet facsimile gateway apparatus according to claim 7, wherein said pseudo signal is a signal for establishing synchronism between transmission/reception apparatuses.

10. The method for controlling an Internet facsimile gateway apparatus according to claim 7, wherein said predetermined period of time is a length of time defined by procedures for facsimile transmission in said general switched telephone network.

11. A computer readable recording medium that stores a control program of an Internet facsimile gateway apparatus that is connected to a general switched telephone network and an IP network and relays facsimile communication between the general switched telephone network and the IP network, comprising:
a program of a first communication step for performing procedural processing of facsimile transmission in said general switched telephone network;
a program of a second communication step for performing procedural processing of facsimile transmission in said IP network; and
a program of a control step for controlling a transmission timing of a signal transmitted by said program of said first communication step based on a signal received by said program of said second communication step.
